(19) United States
(12) Patent Application Publication
(10) Pub. No.: US 2025/0187573 A1
(43) Pub. Date: Jun. 12, 2025

(54) HYDRAULIC PRESSURE SUPPLY DEVICE

(71) Applicant: HL MANDO CORPORATION, Gyeonggi-do (KR)

(72) Inventor: Kwangseok HONG, Gyeonggi-do (KR)

(21) Appl. No.: 18/845,431

(22) PCT Filed: Mar. 7, 2023
(86) PCT No.: PCT/KR2023/003129

§ 371 Date: Sep. 10, 2024

(30) Foreign Application Priority Data
Mar. 10, 2022 (KR) 10-2022-0030296

(51) Int. Cl. B60T 13/16; B60T 13/74; B60T 17/02; F16H 25/22

(52) U.S. Cl. CPC B60T 13/168; B60T 13/745; B60T 17/02; F16H 25/2204; B60Y 2304/05

(57) ABSTRACT

Disclosed is a hydraulic pressure supply device. According to an aspect of the present disclosure, provided is a hydraulic pressure supply device comprising: a motor coupled to one side of a modulator block, which is provided with a flow path and a valve, and having a first hollow portion; a pump housing coupled to the other side of the modulator block and having a second hollow portion; a ball nut connected to the rotary shaft and prevented from rotating by a rotating preventing means; and a piston formed in a cylindrical shape through which a piston hole is formed in the lengthwise direction and of which one end is coupled to the ball nut, and the other end is provided with a head portion having a diameter greater than the diameter of a body portion connected to the ball nut. The piston is provided in the second hollow portion.

### TECHNICAL FIELD

The present disclosure relates to a hydraulic pressure supply device, and more particularly, to a hydraulic pressure supply device provided in an electronic brake system to generate a hydraulic pressure.

### BACKGROUND ART

In general, vehicles are essentially equipped with a brake system for braking, and recently, various types of electronic brake systems have been proposed to obtain a stronger and more stable braking force. As an example, an intelligent integrated dynamic brake (IDB) system is being proposed.

This integrated electronic brake system includes a hydraulic pressure supply device in which an operation of a brake pedal is electrically output as an electric signal through a pedal displacement sensor, and a motor operates, and a rotary force of the motor is converted into a linear movement to generate a braking hydraulic pressure, a modulator block having a plurality of valves installed so as to receive a hydraulic pressure with a force generated by the hydraulic pressure supply device and control a braking operation, and an electronic control unit controlling the motor and the valves.

Meanwhile, the hydraulic pressure supply device is installed in the modulator block, and provides a required braking hydraulic pressure by pressurizing an operating fluid in a pump housing with a piston through a structure of converting the rotary force of the motor into the linear movement. For example, the piston moves forward in a direction distant from the motor according to the operation of the motor and presses the operating fluid in the pump chamber, thereby generating an operating hydraulic pressure.

However, the conventional hydraulic pressure supply device requires multiple sealing members to prevent the operating fluid from leaking between the pump housing, and the modulator block and the motor when the piston operates, making the structure complex and increasing manufacturing costs.

### DISCLOSURE

### Technical Problem

A hydraulic pressure supply device according to an exemplary embodiment of the present disclosure has a simple structure, which can not only reduce the number of installation sealing members compared to the conventional one, can but also make packaging easier, thereby reducing costs.

### Technical Solution

According to an aspect of the present disclosure, provided is a hydraulic pressure supply device including: a motor coupled to one side of a modulator block, which is provided with a flow path and a valve for adjusting a braking hydraulic pressure therein, and having a first hollow portion formed therein in which a rotary shaft is accommodated; a pump housing coupled to the other side of the modulator block and having a second hollow portion formed therein, the second hollow portion being in communication with the first hollow portion; a ball nut connected to the rotary shaft so that the rotating movement of the rotary shaft is converted into a linear movement; and a piston formed in a cylindrical shape through which a piston hole is formed in the lengthwise direction and of which one end is coupled to the ball nut so as to move along with the ball nut, and the other end is provided with a head portion having a diameter greater than the diameter of a body portion connected to the ball nut, in which the piston is provided in the second hollow portion and is moved from a distant direction into a close direction of the motor so as to form a hydraulic pressure only in a single direction.

Further, the hydraulic pressure supply device may include a first sealing member provided between the pump housing and the head portion; a second sealing member provided between the pump housing and the modulator block; and a third sealing member provided between the piston and the modulator block.

In addition, the first hollow portion and the second hollow portion may be in communication with each other in a straight line.

Further, the second hollow portion may be partitioned into a pump chamber formed by the head portion outside the piston, and an accommodation portion formed by the piston hole inside the piston.

In addition, the pump housing may be coupled to a mounting hole formed to penetrate the modulator block, but fixed to the modulator block by a fastening member.

Further, the pump housing may include a flange which protrudes along an outer peripheral surface, and the fastening member may press the flanges, and may be coupled to the modulator block.

In addition, the pump housing may further include a support portion of which one side is opened to be in communication with the piston hole.

Further, the support portion may be provided to be inserted into the piston hole.

In addition, a stopper, which is provided to be contactable with the end of the support portion and limits a moving distance of the piston, may protrude on an inner surface of the piston.

Further, the hydraulic pressure supply device may further include a sensor assembly coupled on the same axis as the rotary shaft, and measuring a rotation amount of the rotary shaft.

Further, the sensor assembly may include a shaft connected in a straight line on the same axis as the rotary shaft, and rotating along with the rotary shaft, a holder in which one end is fixed to a shaft, and an accommodation space is provided at the other end, and a magnet mounted on the accommodation space of the holder.

In addition, the sensor assembly may further include a tolerance ring mounted on an outer peripheral surface of the shaft, and the shaft may be inserted and coupled into a mounting groove formed on the rotary shaft by the tolerance ring.

Further, the sensor assembly may further include a bearing rotatably supporting the shaft, and the bearing may be supported on the pump housing.

In addition, the hydraulic pressure supply device may further include a rotating preventing means converting a rotating movement of the rotary shaft into a linear movement, and the rotating preventing means may include a sleeve provided between a rotor and the ball nut, and having a plurality of rotating preventing grooves provided in a progress direction of the piston, and at least one rotating preventing protrusion protruding in a radial direction from an outer peripheral surface of the ball nut, and inserted into the rotating preventing groove, and the rotating preventing protrusion may limit rotation of the ball nut while moving along the rotating preventing groove during the operation of the piston.

Further, the sleeve may be fixed to a motor housing surrounding the motor, or the modulator block.

In addition, the rotating preventing means may further include a rotating preventing ring coupled to the ball nut, and having a restraining protrusion inserted into the rotating preventing groove, and the rotating preventing ring may have at least one slit fitted with the rotating preventing protrusion.

Further, the restraining protrusion and the rotating preventing protrusion may be provided to be spaced apart from each other at a predetermined interval, and inserted into rotating preventing grooves at different positions, respectively.

In addition, the motor may include a stator and a rotor, and the rotary shaft may rotate along with the rotor.

The rotor may include a rotating body which is hollow in a lengthwise direction, and the rotary shaft may be located at and coupled to the inside of the rotating body.

The rotating body may be supported on the motor housing surrounding the motor by a front bearing provided in a front, and a rear bearing provided in a rear.

### Advantageous Effects

The hydraulic pressure supply device according to an exemplary embodiment of the present disclosure can reduce manufacturing costs by changing a pressing direction of the piston and reducing the number of installation sealing members compared to the prior art, and can also improve manufacturing efficiency by simplifying a structure.

In addition, there is an effect in which by easily maintaining a gap between a magnet and a motor position sensor, it is possible to effectively identify an operating state of the motor.

### DESCRIPTION OF DRAWINGS

The present disclosure will be explained in detail with the drawings below, but since these drawings show preferred exemplary embodiments of the present disclosure, the technical idea of the present disclosure should not be construed as limited to the drawings.

FIG. 1 is a perspective view illustrating a hydraulic pressure supply device according to an exemplary embodiment of the present disclosure.

FIG. 2 is a cross-sectional view taken along line II-II′ of FIG. 1.

FIG. 3 is an exploded perspective view illustrating a rotating preventing means provided in the hydraulic pressure supply device according to an exemplary embodiment of the present disclosure.

FIG. 4 is an assembly perspective view of FIG. 3.

FIG. 5 is an exploded cut-out perspective view illustrating a state in which the hydraulic pressure supply device is assembled according to an exemplary embodiment of the present disclosure.

FIG. 6 is a diagram illustrating a state in which a pump housing and a piston of FIG. 5 are assembled to a modulator block.

FIG. 7 is a perspective view illustrating a sensor assembly provided in the hydraulic pressure supply device according to an exemplary embodiment of the present disclosure.

FIGS. 8 and 9 are enlarged diagrams of a part of the hydraulic pressure supply device according to an exemplary embodiment of the present disclosure, respectively.

FIG. 10 is a cross-sectional view illustrating an operating state of a hydraulic pressure supply device according to an exemplary embodiment of the present disclosure.

### MODE FOR INVENTION

Hereinafter, exemplary embodiments of the present disclosure will be described in detail with reference to the accompanying drawings. The following exemplary embodiment is to fully present the idea of the present disclosure to those skilled in the art to which the present disclosure pertains. The present disclosure is not limited to exemplary embodiments described presented herein and may be embodied in other forms. In the drawings, illustration of parts not related to the description to clarify the present disclosure may be omitted, and the size of a component may be slightly exaggerated and expressed to help understanding.

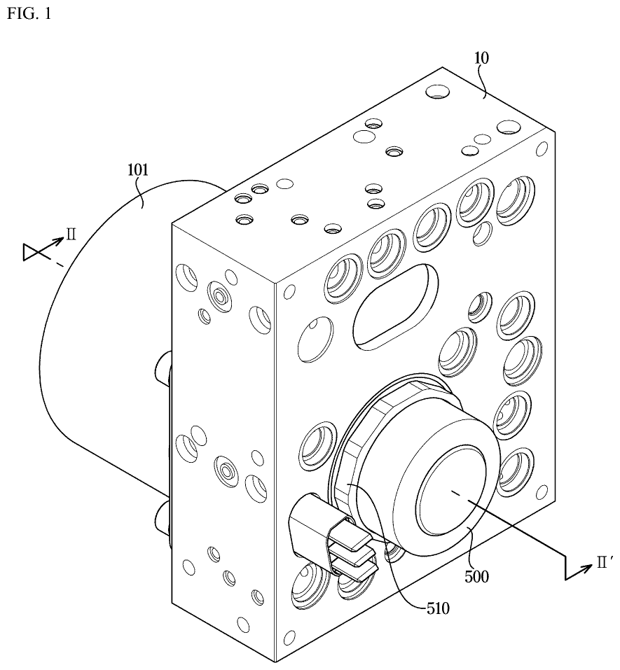

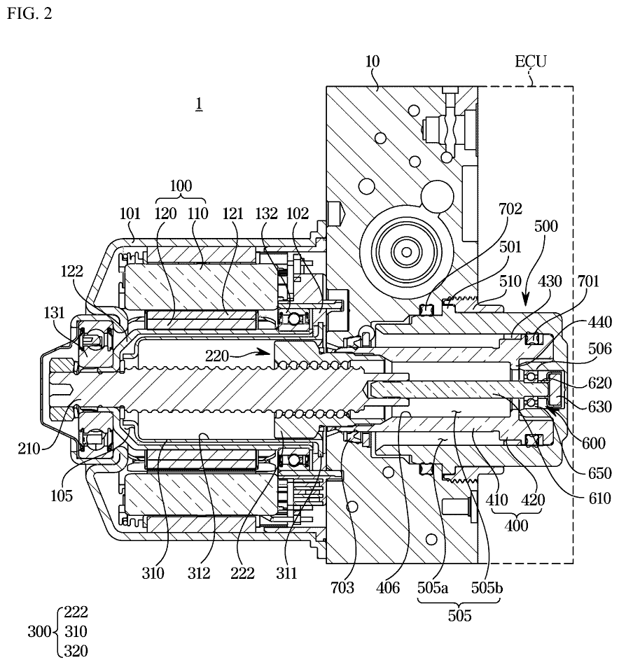

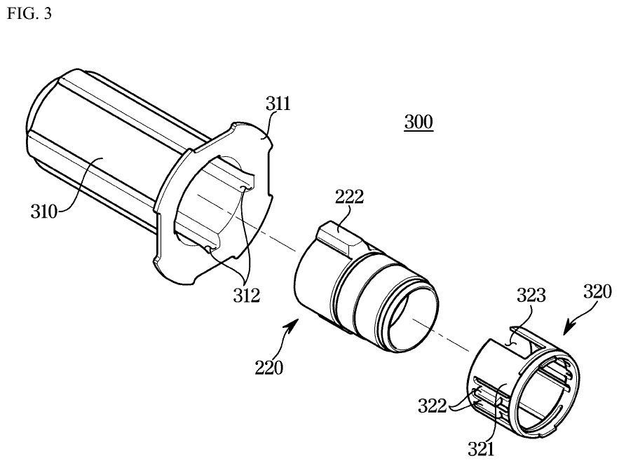

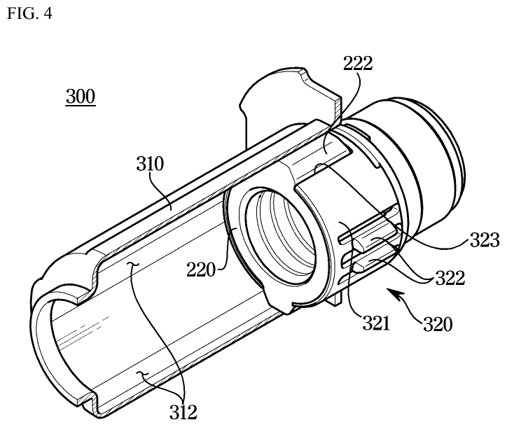

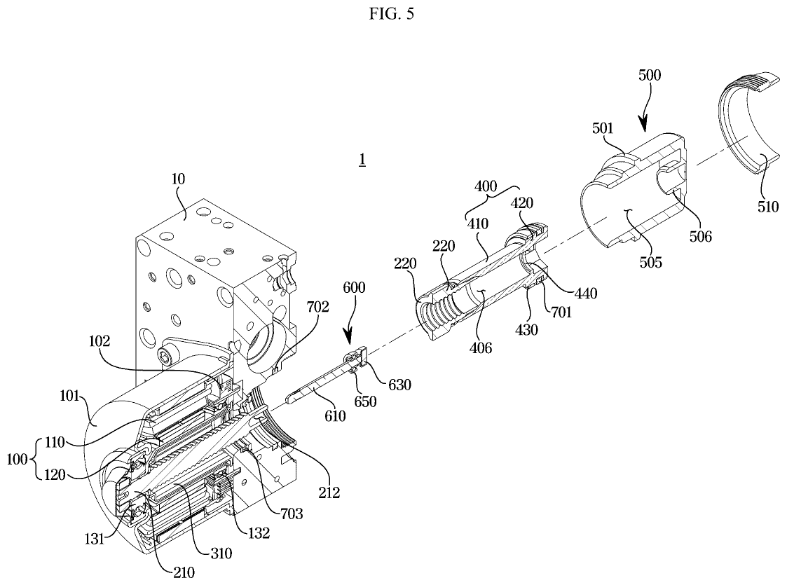

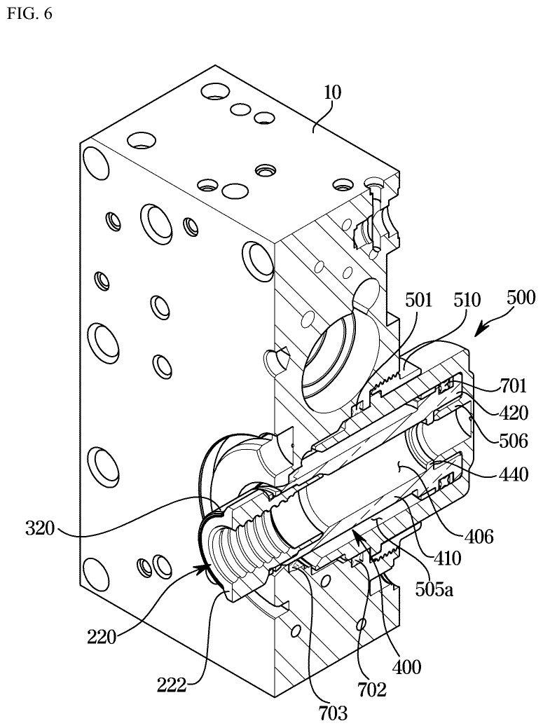

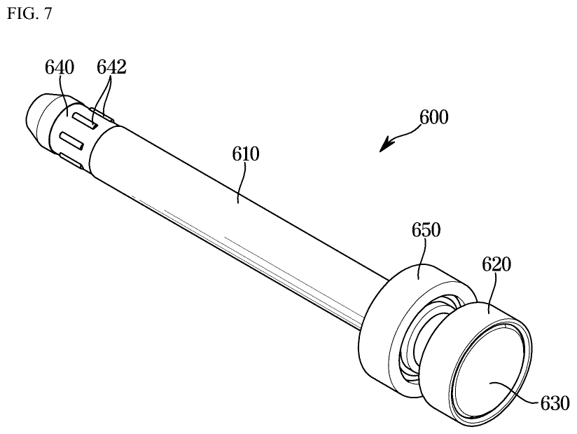

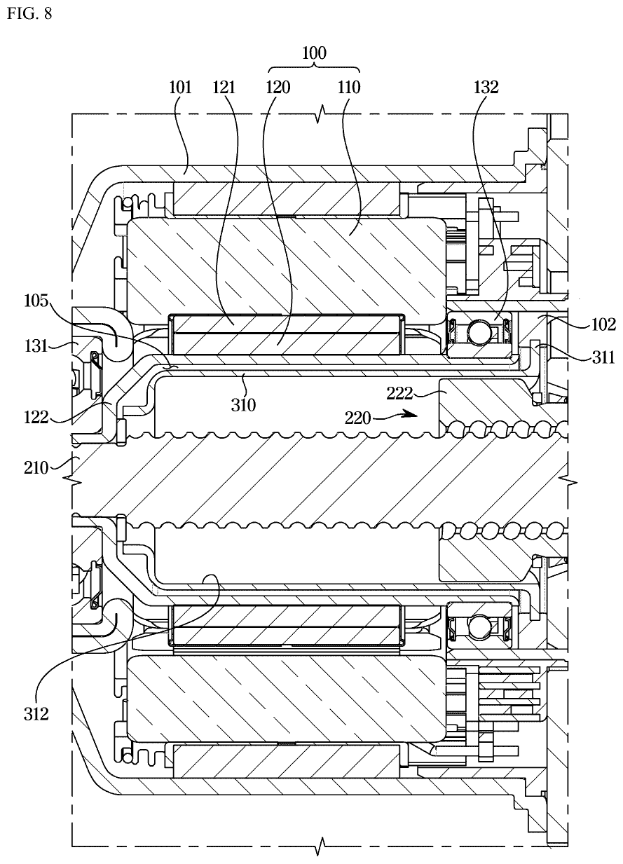

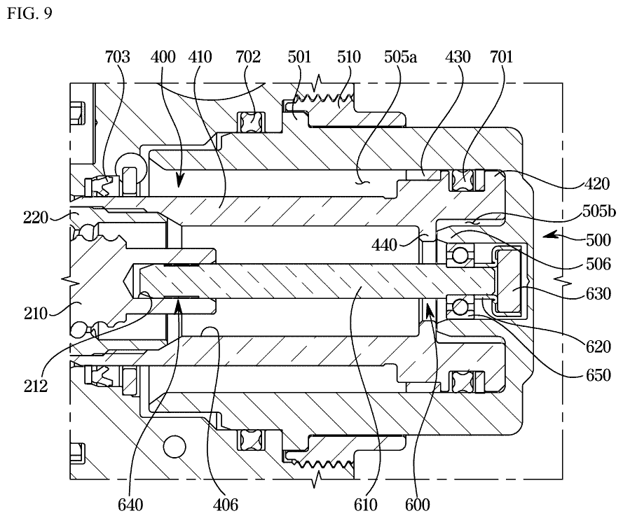

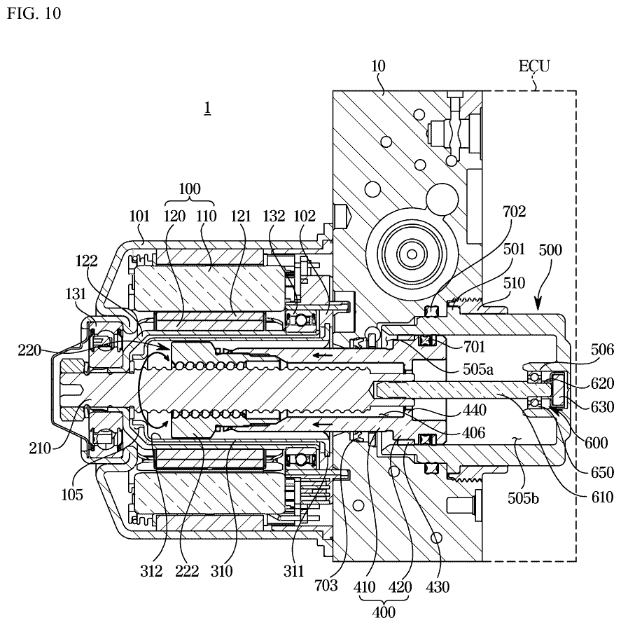

FIG. 1 is a perspective view illustrating a hydraulic pressure supply device according to an exemplary embodiment of the present disclosure, FIG. 2 is a cross-sectional view taken along line II-II′ of FIG. 1, FIG. 3 is an exploded perspective view illustrating a rotating preventing means provided in the hydraulic pressure supply device according to an exemplary embodiment of the present disclosure, FIG. 4 is an assembly perspective view of FIG. 3, FIG. 5 is an exploded cut-out perspective view illustrating a state in which the hydraulic pressure supply device is assembled according to an exemplary embodiment of the present disclosure, FIG. 6 is a diagram illustrating a state in which a pump housing and a piston of FIG. 5 are assembled to a modulator block, FIG. 7 is a perspective view illustrating a sensor assembly provided in the hydraulic pressure supply device according to an exemplary embodiment of the present disclosure, FIGS. 8 and 9 are enlarged diagrams of a part of the hydraulic pressure supply device according to an exemplary embodiment of the present disclosure, respectively, and FIG. 10 is a cross-sectional view illustrating an operating state of a hydraulic pressure supply device according to an exemplary embodiment of the present disclosure.

Referring to FIGS. 1 to 10, a hydraulic pressure supply device 1 according to an aspect of the present disclosure includes a motor 100 coupled to one side of a modulator block 10, a rotary shaft 210 coupled to a rotor 120 of the motor 100, a pump housing 500 coupled to the other side of the modulator block 10, a ball nut 220 connected to the rotary shaft 210 in a ball-screw manner, a rotating preventing means 300 preventing the rotary shaft 210 and the ball nut 220 from rotating along with each other, a piston 400 coupled to the ball nut 220, and a sensor assembly 600 coupled to the rotary shaft 210.

The modulator block 10 is connected to the hydraulic pressure supply device 1 and the master cylinder (not illustrated), and a flow path and a valve for controlling the braking hydraulic pressure are provided inside. In addition, an electronic control unit (ECU) is installed in the modulator block 10, and the electronic control unit (ECU) controls the valve and the motor 100 of the hydraulic pressure supply device 1, thereby transmitting the braking hydraulic pressure to a wheel cylinder provided in each vehicle wheel. At this time, the electronic control unit (ECU) may be provided with a sensing unit (not illustrated) that detects a change in a magnetic field caused by a magnet 630 of the sensor assembly 600, which will be described later. Since the modulator block 10 is a well-known technology widely used in electronic brake systems, a detailed description will be omitted.

A motor housing 101 and a pump housing 500 are fastened to both surfaces of the modulator block 10, respectively. At this time, the motor housing 101 and the pump housing 500 are installed in the modulator block 10 to face each other so as to be internally communicated. In addition, the pump housing 500 may be installed by being inserted into the mounting hole 15 formed to penetrate the modulator block 10, and a pump chamber 505a for generating braking hydraulic pressure may be formed by assembly with the piston 400. A structure in which the pump housing 500 is installed in a mounting hole 15 will be described again below.

The motor housing 101 is fastened to a left side of the modulator block 10 with reference to FIG. 2 and is provided to surround the motor 100, which will be described later. Further, a motor cover 102 is interposed between the motor 100 and the modulator block 10 disposed in the motor housing 101. That is, the motor housing 101 is fastened to the modulator block 10 in a state of being coupled to the motor cover 102.

The motor 100 is a device that receives power and generates a rotary force. The motor 100 may be a hollow motor equipped with a stator 110 and a rotor 120 installed within the motor housing 101. That is, the motor 100 is formed with a first hollow portion 105 in which the rotary shaft 210 is accommodated at the center thereof. The rotor 120 has a cylindrical shape with an empty center, and magnetic bodies 121 are installed at predetermined intervals along an outer peripheral surface. The stator 110 is spaced apart from the rotor 120 at a certain distance and is formed to surround the rotor 120. When a coil (not illustrated) is wound around the stator 110 and power is applied, repulsive and attractive forces are applied between a magnetic body 121 and the coil, causing the rotor 120 to rotate. Since the structures of the rotor 120 and the stator 110 of the motor 100 are a well-known technology, a detailed description will be omitted.

Meanwhile, as the hydraulic pressure supply device 1 of the present disclosure is applied to and used in the electronic brake system, the motor 100 may operate through an electric signal from a pedal displacement sensor (not illustrated) that detects a displacement according to a pedal effort of a brake pedal. In other words, the motor 100 rotates forward and backward and generates the rotary force to perform a braking force requested by a driver.

The rotary shaft 210 has a predetermined length and is disposed in the first hollow portion 105 formed in the center of the motor 100 to rotate along with the rotor 120. As illustrated, the rotary shaft 210 may be provided to rotate along with a rotating body 122 of the rotor 120.

The rotating body 122 may be hollow in a lengthwise direction so that the rotary shaft 210 is located inside. At this time, a rear side (left side based on FIG. 2) of the rotating body 122 is provided to have a reduced inner diameter and is coupled to rotate along with the rotary shaft 210. This rotating body 122 is supported on front and rear sides by a front bearing 132 and a rear bearing 131, respectively, so as to rotate stably along with the rotor 120.

The rear bearing 131 is interposed between the motor housing 101 and the rotating body 122, and supports the rear side of the rotating body 122, and the front bearing 132 is interposed between the motor cover 102 and the rotating body 122, and supports the front side of the rotating body 122. That is, the front bearing 132 and the rear bearing 131 stably support the front and rear of the rotating body 122, so that when the rotor 120 rotates, the rotor 120 rotates along with the rotating body 122 without shaking.

The rotary shaft 210 may be provided as a screw shaft that is press-fitted into the rotating body 122 or coupled to the rotating body 122 in a spline structure and rotates along with the rotating body 122. That is, the rotary shaft 210 has a predetermined length, a screw groove is formed on the outer peripheral surface, and the rear is fixed to the rear side of the rotating body 122, so that the rotary shaft 210 rotates along with the rotating body 122.

The ball nut 220 is coupled to the rotary shaft 210 in a ball-screw manner to convert a rotating movement into a linear reciprocating movement. Although not illustrated, a plurality of balls may be filled between the rotary shaft 210 and the ball nut 220 to reduce energy due to friction. That is, the rotary shaft 210 and the ball nut 220 may be provided as a ball-screw-type power conversion unit. The ball nut 220 is provided in a state in which rotation is restricted by the rotating preventing means 300. Accordingly, the rotating movement of the rotary shaft 210 is converted into the linear movement and the ball nut 220 moves in the lengthwise direction of the rotary shaft 210.

The rotating preventing means 300 may include a sleeve 310 having at least one rotating preventing groove 312 formed on the inner surface in the lengthwise direction and a rotating preventing protrusion 222 protruding from the outer peripheral surface of the ball nut 220 to be inserted into the rotating preventing groove 312.

A sleeve 310 is hollow in the lengthwise direction so that the ball nut 220 is located inside, and at least one rotating preventing groove 312 is formed on the inner surface in the lengthwise direction. A plurality of rotating preventing grooves 312 may be provided to be spaced apart in parallel at equal intervals in a circumferential direction on the inner surface of the sleeve 310. In addition, the sleeve 310 may be disposed to be spaced apart from the rotating body 122 at a certain distance so as not to interfere with the rotor 120, and may include a bending portion 311 in which the other side is bent and fixed to the motor housing 101 or the modulator block 10. As illustrated, the bending portion 311 may be fixed to the motor cover 102. That is, as the motor cover 102 is fixed to the modulator block 10 along with the motor housing 101, the movement of the sleeve 310 is also limited.

The rotating preventing protrusions 222 are formed along the outer peripheral surface of the ball nut 220, and are preferably formed to have a number corresponding to the rotating preventing grooves 312, but are not limited thereto. For example, the rotating preventing protrusions 222 are provided in a pair, spaced apart to have a 180 degree phase difference, and may be inserted into two of the four rotating preventing grooves 312 formed at 90 degree intervals. Accordingly, the rotating preventing protrusion 222 prevents the rotation of the ball nut 220 and moves along the rotating preventing groove 312 as the ball nut 220 moves.

Meanwhile, according to an aspect of the present disclosure, the rotating preventing means 300 may further include a rotating preventing ring 320. The rotating preventing ring 320 may be press-fitted to the outer peripheral surface of the ball nut 220, and at least one restraining protrusion 322 may be formed on the outer peripheral surface. The rotating preventing ring 320 has a ring-shaped body 321, a slit 323 into which the rotating preventing protrusion 222 is inserted on the outer peripheral surface, and a restraining protrusion 322 inserted into the rotating preventing groove 312 formed on the sleeve 310. At this time, the restraining protrusion 322 and the rotating preventing protrusion 222 may be spaced apart from each other at a certain distance and may be inserted into the rotating preventing grooves 312 at different positions, respectively.

The rotating preventing ring 320 not only serves to limit the rotation of the ball nut 220, but also serves to guide the ball nut 220 to move stably when the ball nut 220 moves. In addition, the rotating preventing ring 3230 is in contact with the piston 400 when assembling the piston 400 to the ball nut 220, thereby specifying an assembly range of the piston 400 to prevent damage due to excessive assembly.

The above-described rotating preventing means 300 is implemented through the rotating preventing protrusion 222 formed on the ball nut 220 and the rotating preventing groove 312 formed on the sleeve 310, or to further include the rotating preventing ring 320, but is not limited thereto, and only the rotating preventing ring 320 is coupled to the ball nut 220 without the rotating preventing protrusion 222 to implement a rotating preventing function of the ball nut 220.

The piston 400 is coupled to the ball nut 220 on the opposite side where the rotating preventing protrusion 222 is formed and makes the linear reciprocating movement along with the ball nut 220. The piston 400 is provided to have a cylindrical shape with a piston hole 406 penetrating in the lengthwise direction. Specifically, the piston 400 has a body portion 410 having a predetermined length, one end of which is coupled to the ball nut 220, and a head portion 420 whose other end protrudes to have a diameter larger than the diameter of the body portion 410. The piston 400 is disposed inside the pump housing 500. That is, the piston 400 is disposed so that the end of the head portion 420 is in contact with the end of the other side (right side based on FIG. 2) of the pump housing 500 in a pre-operation state. In addition, the outer peripheral surface of the head portion 420 is provided to be in contact with the inner surface of the pump housing 500, so that a pump chamber 505a accommodating the operating fluid may be formed between the outer surface of the body portion 410 and the inner surface of the pump housing 500.

In addition, a guide bush 430 may be provided on the outer peripheral surface of the piston 400, and as illustrated, the guide bush 430 may be coupled to a step portion of the head portion 420 so that the outer peripheral surface corresponds to the outer peripheral surface of the head portion 420. Accordingly, when the piston 400 moves linearly, the guide bush 430 is guided along the inner surface of the pump housing 500, thereby enabling the piston 400 to perform a stable linear movement.

Meanwhile, the sensor assembly 600, which will be described later, may be accommodated in a piston hole 406. For example, the sensor assembly 600 may be provided so that one side is coupled to the rotary shaft 210 within the piston hole 406 and the other side is supported by the pump housing 500. The assembly structure of this sensor assembly 600 will be described again below.

The pump housing 500 is formed with a second hollow portion 505 opened on one side to communicate in a straight line with the first hollow portion 105 of the motor 100, and is coupled to the mounting hole 15 of the modulator block 10. As illustrated, the mounting hole 15 has a shape that is stepped multiple times in the penetrating direction. Accordingly, the modulator block 10 through the mounting hole 15 may be divided into a part that is coupled to the pump housing 500, and is in close contact with the pump housing 500, and a part that is in close contact with the piston 400. When the pump housing 500 is coupled to the mounting hole 15, the pump housing 500 may be fixed by a fastening member 510 screw-coupled to the modulator block 10. At this time, the pump housing 500 may be press-fitted to the modulator block 10 and then fixed by the fastening member 510. The pump housing 500 has a flange 501 protruding along the outer peripheral surface. One side of the flange 501 may be supported on the stepped portion of the mounting hole 15, and in this state, the fastening member 510 may press the other side of the flange 501 and may be fastened to the modulator block 10.

The second hollow portion 505 may be partitioned into the pump chamber 505a formed by the head portion 420 outside the piston 400 and an accommodation portion 505b formed by the piston hole 406 inside the piston 400. That is, the operating fluid is provided in the pump chamber 505a so that the operating fluid does not leak into the accommodation portion 505b. Accordingly, the operating fluid accommodated in the pump chamber 505a flows in and out of an internal flow path of the modulator block 10 according to the operation of the piston 400.

Further, a plurality of sealing members 701, 702, and 703 may be installed to prevent the operating fluid from leaking out of the pump housing 500, and toward the accommodation portion 505b, and toward the motor 100.

As illustrated, a first sealing member 701 is provided between the pump housing 500 and the head portion 420. The first sealing member 701 is inserted into a groove formed on the outer peripheral surface of the head portion 420 to seal the space between the outer peripheral surface of the head portion 420 and the inner surface of the pump housing 500, thereby preventing leakage of the operating fluid, which allows the hydraulic pressure to be generated smoothly.

Further, a second sealing member 702 is provided between the pump housing 500 and the modulator block 10. The second sealing member 702 is inserted into the groove formed in the mounting hole 15 of the modulator block 10 to seal the space between the modulator block 10 and the outer surface of the pump housing 500.

Further, a third sealing member 703 is provided between the outer peripheral surface of the body portion 410 of the piston 400, and the modulator block 10. The third sealing member 703 is provided in the groove formed in the mounting hole 15 of the modulator block 10 to seal the space between the modulator block 10 and the outer surface of the piston 400, thereby preventing the operating fluid from leaking toward the motor 100. At this time, with respect to the first and third sealing members 701 and 703, ring members may be installed at grooves where the first and third sealing members 701 and 703 are provided, respectively to minimize damage due to friction and deformation that occur during operation of the piston 400.

As described above, in a state sealed by the first to third sealing members 701, 702, and 703, the piston 400 moves from a distant direction to a close direction of the motor 100 and forms the hydraulic pressure only in a single direction, so there is no need to seal the inner diameter of the piston 400. That is, it is possible to prevent the operating fluid from leaking through a total of three sealing members 701, 702, and 703.

Meanwhile, the pump housing 500 may further include a support portion 506 with one side opened so as to communicate with the piston hole 406 at a position corresponding to the piston hole 406. The support portion 506 is a portion on which the sensor assembly 600, which will be described later, is mounted, and may be provided to be inserted into the piston hole 406.

In addition, a stopper 440 that contacts the end of the support portion 506 inserted into the piston hole 406 may be provided on the inner surface of the piston 400. The stopper 440 protrudes from the inner surface of the piston 400 toward the center, and serves to limit the moving distance of the piston 400 by contacting the support portion 506. At this time, the stopper 440 must be formed so as not to interfere with the sensor assembly 600 accommodated in the piston hole 406.

The sensor assembly 600 is coupled to the rotary shaft 210 and serves to measure a rotation direction and a rotation amount of the rotary shaft 210. Specifically, the sensor assembly 600 may include a shaft 610 connected in a straight line on the same axis as the rotary shaft 210, a holder 620 fixed to the end of a shaft 610, a magnet 630 mounted on the holder 620, and a tolerance ring 640 mounted on the outer peripheral surface of the shaft 610.

The shaft 610 has a predetermined length, and one end may be press-fitted into the mounting groove 212 formed at the end of the rotary shaft 210. At this time, the tolerance ring 640 mounted on the outer peripheral surface of the shaft 610 may be inserted into the mounting groove 212 and coupled with the shaft 610. The tolerance ring 640 has an elastic portion 642 on its outer surface that has a protrusion shape and is deformable by external force. Accordingly, the shaft 610 is constrained in the rotation direction with the rotary shaft 210 by the tolerance ring 640 and rotates in the same direction.

The holder 620 has an accommodation space in which one end is fixed to the end of the shaft 610, and the magnet 630 is installed at the other end. That is, the holder 620 and the magnet 630 are provided on the opposite side of the shaft 610 coupled to the rotary shaft 210. Accordingly, when the shaft 610 rotates along with the rotary shaft 210, the holder 620 and the magnet 630 rotate together.

Meanwhile, the sensor assembly 600 further includes a bearing 650 that rotatably supports the shaft 610. The bearing 650 is supported on the inside of the support portion 506 to support a radial direction of the shaft 610 so that the shaft 610 and the magnet 630 may rotate stably.

The sensor assembly 600 may include a sensing unit (not illustrated) provided in an electronic control unit (ECU). The sensing unit detects changes in the magnetic field caused by the magnet 630 and measures the rotation direction and the rotation amount of the rotary shaft 210. That is, based on the information detected by the sensing unit, the electronic control unit (ECU) may determine the movement of the piston 400 and control the operation of the motor 100.

As described above, although the present disclosure has been described by means of limited embodiments and drawings, the present disclosure is not limited thereto, and various modifications and variations are possible by those skilled in the art within the scope of the technical idea of the present disclosure and the equivalent scope of the patent claims to be described below.

1. A hydraulic pressure supply device comprising:
a motor coupled to one side of a modulator block, which is provided with a flow path and a valve for adjusting a braking hydraulic pressure therein, and having a first hollow portion formed therein in which a rotary shaft is accommodated;
a pump housing coupled to the other side of the modulator block and having a second hollow portion formed therein, the second hollow portion being in communication with the first hollow portion;
a ball nut connected to the rotary shaft and converting a rotating movement of the rotary shaft into a linear movement; and
a piston formed in a cylindrical shape through which a piston hole is formed in a lengthwise direction and of which one end is coupled to the ball nut so as to move along with the ball nut, and the other end is provided with a head portion having a diameter greater than a diameter of a body portion connected to the ball nut,
wherein the piston is provided in the second hollow portion and is moved from a distant direction into a close direction of the motor so as to form a hydraulic pressure only in a single direction.

2. The hydraulic pressure supply device of claim 1, further comprising:
a first sealing member provided between the pump housing and the head portion;
a second sealing member provided between the pump housing and the modulator block; and
a third sealing member provided between the piston and the modulator block.

3. The hydraulic pressure supply device of claim 1, wherein the first hollow portion and the second hollow portion are in communication with each other in a straight line.

4. The hydraulic pressure supply device of claim 3, wherein the second hollow portion is partitioned into a pump chamber formed by the head portion outside the piston, and an accommodation portion formed by the piston hole inside the piston.

5. The hydraulic pressure supply device of claim 1, wherein the pump housing is coupled to a mounting hole formed to penetrate the modulator block, but fixed to the modulator block by a fastening member.

6. The hydraulic pressure supply device of claim 5, wherein the pump housing includes a flange which protrudes along an outer peripheral surface, and
the fastening member presses the flanges, and is coupled to the modulator block.

7. The hydraulic pressure supply device of claim 1, wherein the pump housing further includes a support portion of which one side is opened to be in communication with the piston hole.

8. The hydraulic pressure supply device of claim 7, wherein the support portion is provided to be inserted into the piston hole.

9. The hydraulic pressure supply device of claim 7, wherein a stopper, which is provided to be contactable with an end of the support portion and limits a moving distance of the piston, protrudes on an inner surface of the piston.

10. The hydraulic pressure supply device of claim 1, further comprising:
a sensor assembly coupled on the same axis as the rotary shaft, and measuring a rotation amount of the rotary shaft.

11. The hydraulic pressure supply device of claim 10, wherein the sensor assembly includes
a shaft connected in a straight line on the same axis as the rotary shaft, and rotating along with the rotary shaft,
a holder in which one end is fixed to a shaft, and an accommodation space is provided at the other end, and
a magnet mounted on the accommodation space of the holder.

12. The hydraulic pressure supply device of claim 11, wherein the sensor assembly further includes a tolerance ring mounted on an outer peripheral surface of the shaft, and
the shaft is inserted and coupled into a mounting groove formed on the rotary shaft by the tolerance ring.

13. The hydraulic pressure supply device of claim 11, wherein the sensor assembly further includes a bearing rotatably supporting the shaft, and
the bearing is supported on the pump housing.

14. The hydraulic pressure supply device of claim 1, further comprising:
a rotating preventing means converting a rotating movement of the rotary shaft into a linear movement,
wherein the rotating preventing means includes
a sleeve provided between a rotor and the ball nut, and having a plurality of rotating preventing grooves provided in a progress direction of the piston, and
at least one rotating preventing protrusion protruding in a radial direction from an outer peripheral surface of the ball nut, and inserted into the rotating preventing groove, and
the rotating preventing protrusion limits rotation of the ball nut while moving along the rotating preventing groove during operation of the piston.

15. The hydraulic pressure supply device of claim 14, wherein the sleeve is fixed to a motor housing surrounding the motor, or the modulator block.

16. The hydraulic pressure supply device of claim 14, wherein the rotating preventing means further includes a rotating preventing ring coupled to the ball nut, and having a restraining protrusion inserted into the rotating preventing groove, and
the rotating preventing ring has at least one slit fitted with the rotating preventing protrusion.

17. The hydraulic pressure supply device of claim 16, wherein the restraining protrusion and the rotating preventing protrusion are provided to be spaced apart from each other at a predetermined interval, and inserted into the rotating preventing grooves at different positions, respectively.

18. The hydraulic pressure supply device of claim 1, wherein the motor includes a stator and a rotor, and
the rotary shaft rotates along with the rotor.

19. The hydraulic pressure supply device of claim 18, wherein the rotor includes a rotating body which is hollow in the lengthwise direction, and
the rotary shaft is located at and coupled to inside of the rotating body.

20. The hydraulic pressure supply device of claim 19, wherein the rotating body is supported on a motor housing surrounding the motor by a front bearing provided in a front, and a rear bearing provided in a rear.
